(19) United States
(12) Patent Application Publication
(10) Pub. No.: US 2025/0040496 A1
(43) Pub. Date: Feb. 6, 2025

(54) CLEANABLE MOBILE DRIP IRRIGATION SYSTEM

(71) Applicant: Tyler Rendleman, Harrison, MI (US)

(72) Inventor: Tyler Rendleman, Harrison, MI (US)

(21) Appl. No.: 18/363,847

(22) Filed: Aug. 2, 2023

(51) Int. Cl. A01G 25/02

(52) U.S. Cl. CPC A01G 25/023

(57) ABSTRACT

A drip irrigation unit includes conduits for delivering the irrigation water in small quantities directly to the plants being irrigated. The water is pressurized and dripped onto the soil adjacent to the plant. It can, however, be delivered in a slow trickle to the soil. The device includes a system that can be utilized to clean the device when it becomes clogged and ceases to drip.

### CROSS-REFERENCE TO RELATED APPLICATIONS

Not Applicable.

### STATEMENT REGARDING FEDERALLY SPONSORED RESEARCH OR DEVELOPMENT

Not Applicable.

### REFERENCE TO SEQUENCE LISTING, A TABLE, OR A COMPUTER PROGRAM LISTING COMPACT DISC APPENDIX

Not Applicable.

### BACKGROUND OF THE INVENTION

A drip irrigation unit includes conduits for delivering the irrigation water in small quantities directly to the plants being irrigated. The water is pressurized and dripped onto the soil adjacent to the plant. It can, however, be delivered in a slow trickle to the soil.

Flow rates for these types of irrigators are typically in the neighborhood of one gallon per hour of water at a pressure of about twenty-five pounds per square inch.

Because of the small opening in the irrigator for releasing the water, the irrigation units become easily plugged and prevent the even flow of water.

The instant invention provides a means by which the irrigation unit and be unplugged and otherwise cleaned so that an even, continual supply of water is maintained.

One such known prior art irrigation unit can be found in U.S. Pat. No. 3,753,527, that issued to Galbraith on Aug. 21, 1973, which deals with a drip irrigation system that will allow particles to pass through the exit orifices.

U.S. Patent Publication 2003/0001029 that published on Jan. 2, 2003, to Neyestani deals with a self-discharging drip irrigation device.

U.S. Pat. No. 7,048,010 that issued on May 23, 2006, to Rolan, et al, deals with a drip irrigation system that is low pressure using feeder pipes and drip pipes.

Prior art advertised units consist of Bloom brothers GGWR06 inch hydro Halo Water; 3″ Matrix Circulator; Hydro flow Rain ring drip emitter; Matrix Circulator 3″ drip irrigation ring, and Halo Water Ring Hydroponics Soil Drip Irrigator.

### BRIEF SUMMARY OF THE INVENTION

Thus, what is disclosed and claimed herein is a cleanable mobile drip irrigation unit. The unit comprises a semi-circular hollow ring having an interrupted ring opening and two open terminal cleaning ports, a plurality of small spaced-apart openings in a surface of said semi-circular hollow ring, and an inlet port for pressurized water.

### BRIEF DESCRIPTION OF THE SEVERAL VIEWS OF THE DRAWING(S)

FIG. 1 is a full top view of a device of this invention showing a square tube configuration.

FIG. 2 is a full top view of a device of this invention showing a round tube configuration.

FIG. 3 is a full side view of the device of FIG. 1.

FIG. 4 is a full side view of the device of FIG. 2.

FIG. 5 is a full bottom perspective view of a device of this invention.

FIG. 6 is a full side view of a plug for a device of this invention.

### DETAILED DESCRIPTION OF THE INVENTION AND DRAWINGS

What is disclosed and claimed herein is a cleanable mobile drip irrigation unit.

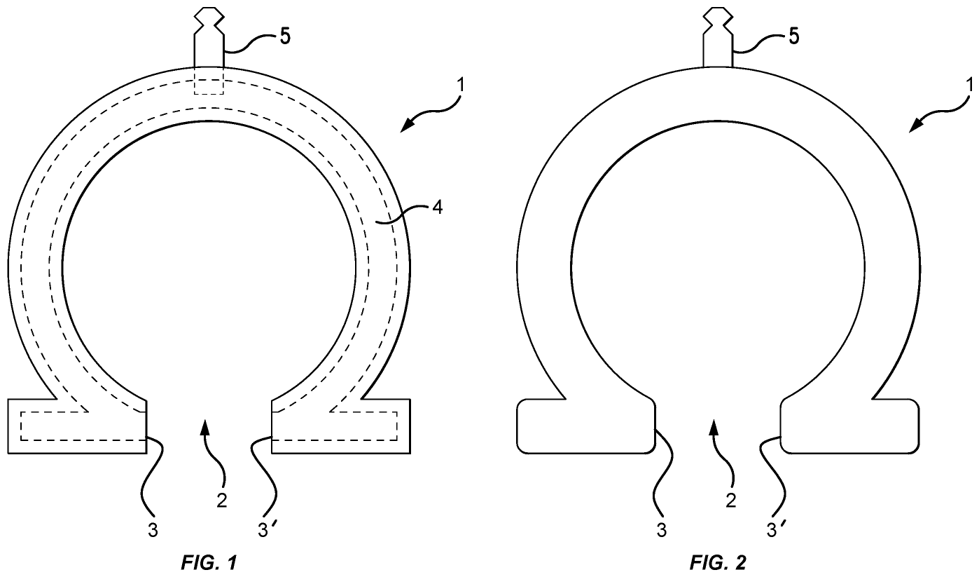

With regard to FIG. 1, there is shown a full bottom view of a semi-circular hollow ring 1 having an interrupted ring opening 2 and two open terminal cleaning ports 3 and 3′. By “interrupted ring opening” 2, it is meant that the ring is not fully circular but has a gap existing between two terminal ends as shown in FIGS. 1 and 2.

Also shown is the hollow portion 4 that allows water to be pushed through the semi-circular hollow ring which is shown in phantom. Further shown is an input nozzle 5 for inputting water into the ring 1 by the attachment of a pressurized hose (the hose is not part of the invention). Water is supplied to the device such that the water is under pressure, like for example, from a water hose or the like.

There is a plurality of small spaced-apart openings 6 in a surface of the semi-circular hollow ring 1 as is shown in FIG. 5. These opening have a diameter of about 1 to 6 mm, just enough opening that the water contained inside the ring 1 can drip or drizzle from the device to the ground. These openings 6 can be in a bottom surface of the ring 1, the top surface of the ring 1 or the side wall 7 of the ring 1, or a combination of such openings. These openings are designated “drip emitters” in the art.

Also shown in FIG. 5 are spiked support legs 8. Typically, there are four or five such legs, but usually three is both efficient and economical.

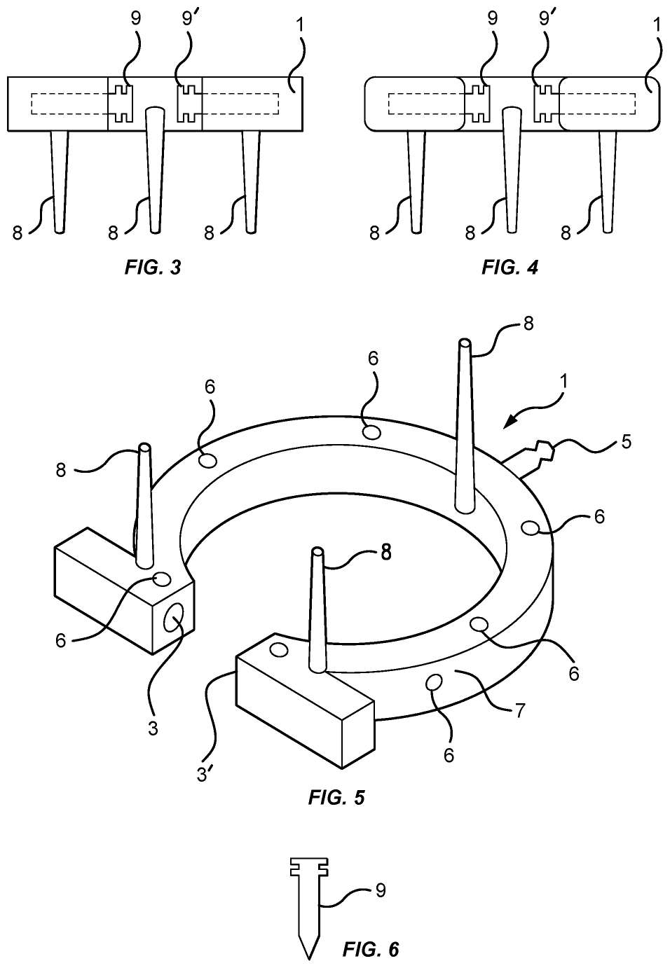

Turning now to FIG. 3 which is a full side view of the device of FIG. 1 and FIG. 4 which is a full side view of the device of FIG. 2 and note that the support legs are shown as 8. There is shown in FIG. 5 an opening 3 for cleaning the semi-circular tube with a brush. There is an identical cleaning opening 3′ at the end of the opposite end of the semi-circular ring 1 that is not shown. FIGS. 3 and 4 show stoppers 9 and 9′ for closing the openings 3 and 3′ (see FIG. 6). When it is desired to clean the interior of the ring 1, the stoppers 9/9′ are removed and a brush or some similar instrument is inserted to remove any debris in the interior of the ring 1.

The semi-circular hollow ring is tubular, and the tube has a diameter of ¼ inch to 2 inches. The diameter of the ring is 4 inches to 8 inches and the hollow interior of the hollow ring is ¼ to 1⅞ inches in diameter.

What is claimed is:

1. A cleanable mobile drip irrigation unit, said unit comprising:
a semi-circular hollow ring having an interrupted ring opening and two open terminal cleaning ports;
a plurality of small spaced-apart openings in a surface of said semi-circular hollow ring, and
an inlet port for pressurized water.

2. A mobile irrigation system as claimed in claim 1 wherein said small spaced-apart openings in said surface have a diameter of 1 mm to 6 mm.

3. A mobile irrigation system as claimed in claim 1 wherein, in addition, said mobile irrigation system has at least two support legs.

4. A mobile irrigation system as claimed in claim 3 wherein, in addition, said support legs are spiked.

5. A mobile irrigation system as claimed in claim 1 wherein, in addition, said open terminal ends have stoppers inserted in them.

6. A mobile irrigation system as claimed in claim 5 wherein, in addition, said stoppers are rubber stoppers.

7. A mobile irrigation system as claimed in claim 1 wherein said semi-circular hollow ring is tubular and the tube has a diameter of ¼ inch to 2 inches.

8. A mobile irrigation system as claimed in claim 1 wherein the diameter of the semi-circular ring is 4 inches to 8 inches.

9. A mobile irrigation system as claimed in claim 1 wherein the hollow of said hollow ring is ¼ inch to 1⅞ inches in diameter.

10. A mobile irrigation system as claimed in claim 1 wherein said mobile irrigation system wherein said hollow ring is round.

11. A mobile irrigation system as claimed in claim 1 wherein said semi-circular hollow ring is round in configuration.

12. A mobile irrigation system as claimed in claim 1 wherein said semi-circular hollow ring is round in diameter configuration.

13. A mobile irrigation system as claimed in claim 1 wherein said semi-circular hollow ring is square in diameter configuration.

14. A mobile irrigation system as claimed in claim 1 wherein said semi-circular hollow ring is rectangular in configuration.

15. A mobile irrigation system as claimed in claim 1 wherein said small spaced-apart openings are in a top surface of said semi-circular hollow ring.

16. A mobile irrigation system as claimed in claim 1 wherein said small spaced-apart openings are in a bottom surface of said semi-circular hollow ring.

17. A mobile irrigation system as claimed in claim 1 wherein said small spaced-apart openings are in a side wall of said semi-circular hollow ring.
